(19) United States
(12) Patent Application Publication
(10) Pub. No.: US 2008/0199669 A1
(43) Pub. Date: Aug. 21, 2008

(54) Zinc oxide nanoparticle-containing organic-inorganic composite film, fabrication method for the same and electroluminescent element implemented by the same

(76) Inventors: Chun-Yu Lee, Taipei (TW); Ching-Fuh Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,656

(22) Filed: May 16, 2007

(30) Foreign Application Priority Data
Feb. 15, 2007 (TW) 096105655

(51) Int. Cl. B32B 5/16; B05D 1/12; B32B 7/02; B05D 3/02

(52) U.S. Cl. 428/213; 427/180; 427/384; 428/328; 428/407

(57) ABSTRACT

The present invention discloses an electroluminescent element implemented by a zinc oxide nanoparticle-containing organic-inorganic composite film. In the present invention, a spin-coating technology together with a phase-segregation technology is used to fabricate zinc oxide nanoparticles and an organic electrically-conductive material into a layered organic-inorganic composite film, and an electroluminescent element is fabricated with the layered structure, which can increase the probability of the electron-hole pair recombination in zinc oxide nanoparticles. Thereby, the present invention can realize a low-cost blue light-emitting element having a large emitting area and an extensive application field.

### BACKGROUND OF THE INVENTION

1. Field of the Invention

The present invention relates to a zinc-oxide light-emitting element, particularly to a simple-structure and low-cost zinc oxide nanoparticle-containing organic-inorganic composite film, a fabrication method for the same and an electroluminescent element implemented by the same.

2. Description of the Related Art

Blue light-emitting elements can be used in true-color displays, LCD backlight sources and lighting devices. As a blue light-emitting diode emits a short-wavelength and high-energy light, it can also facilitate some emerging applications, such as applications in medicine, greenhouse agriculture, food processing, etc. Owing to buoyant oil price, many nations are devoted to saving energy and developing new energies. The blue light-emitting diode, in cooperation with fluorescent powder, can implement a white light source, which can save over 70% energy in comparison with the traditional bulb. Therefore, blue light sources have a very high development potential.

At present, the direct-gap semiconductor gallium nitride (GaN) is the mainstream of blue light-emitting elements. Most of GaN blue light-emitting elements are fabricated by MOCVD (Metal Organic Chemical Vapor Deposition) method or MBE (Molecular Beam Epitaxy) method. However, epitaxial equipment is very complicated and expensive. Besides, the epitaxial methods cannot fabricate large-area elements. In addition to gallium nitride, other blue light-emitting materials, such as the direct-gap semiconductor zinc selenium (ZnSe) and the indirect-gap semiconductor silicon carbide (SiC), also need epitaxial technologies.

### SUMMARY OF THE INVENTION

To develop a low-cost blue light-emitting element and benefit the application of display devices, the present invention utilizes the characteristics of zinc oxide-a direct band gap of 3.3 eV and a very high binding energy of 60 meV-to fabricate a zinc oxide nanoparticle-containing electroluminescent element having a large emitting area via a low-cost spin-coating technology and a phase-segregation technology, which are very distinct from the traditional complicated and expensive epitaxial technology.

To achieve the abovementioned objectives, the present invention discloses a zinc oxide nanoparticle-containing organic-inorganic composite film, wherein the mixture solution of zinc oxide nanoparticles and an organic electrically-conductive material is fabricated into an 1.5-2.0 μm thick zinc oxide nanoparticle-containing organic-inorganic composite film via a spin-coating method, and the zinc oxide nanoparticles are distributed above the organic electrically-conductive material via a phase-segregation method to make the organic-inorganic composite film have a layered structure. Then, the layered organic-inorganic composite film is used to fabricate a zinc oxide nanoparticle-containing electroluminescent element.

Current is used to induce the electroluminescence of zinc oxide nanoparticles. When electron-hole pairs flow through zinc oxide nanoparticles, they will be caught by the zinc oxide nanoparticles. The ground-state electrons of the excitons are excited to an excited state. When the excited electrons return to the ground state, photons with energy corresponding to the band gap of zinc oxide will emit. The present invention utilizes an organic electrically-conductive material to increase the holes injected into the zinc oxide nanoparticles. The present invention also utilizes a phase-segregation technology to separate zinc oxide nanoparticles from the organic electrically-conductive material to increase the probability that the zinc oxide nanoparticles catch the electrons coming from the cathode. Thereby, the probability of the recombination of electron-hole pairs in the zinc oxide nanoparticles is greatly increased.

The electroluminescence of the zinc oxide nanoparticle-containing electroluminescent element has a wavelength completely corresponding to the band gap of zinc oxide and can be attained by a direct current at the ambient temperature. Further, the spin-coating method is suitable to fabricate an electroluminescent element with a large emitting area; thus, the cost can be greatly reduced, and the industry of blue light-emitting elements will be benefited.

Below, the embodiments of the present invention are to be described in detailed in cooperation with the drawings to make the objectives, characteristics and efficacies of the present invention easily understood.

### BRIEF DESCRIPTION OF THE DRAWINGS

FIG. 1 is a diagram schematically showing the zinc oxide nanoparticle-containing organic-inorganic composite film according to the present invention;

FIG. 2A to FIG. 2C are diagrams schematically showing the process of fabricating the zinc oxide nanoparticle-containing electroluminescent element according to one embodiment of the present invention;

FIG. 3 is a diagram showing the I-V curves of the zinc oxide nanoparticle-containing electroluminescent elements according to one embodiment of the present invention; and

FIG. 4 is a diagram showing the electroluminescent spectra of the zinc oxide nanoparticle-containing electroluminescent elements according to one embodiment of the present invention.

### DETAILED DESCRIPTION OF THE INVENTION

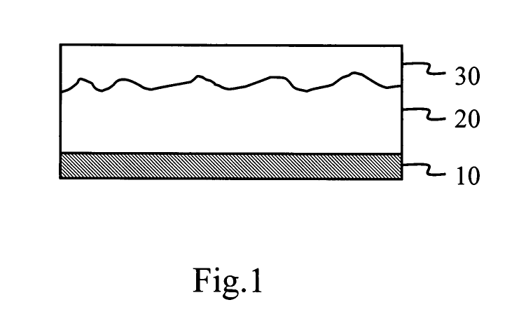

Refer to FIG. 1. The present invention discloses a zinc oxide nanoparticle-containing organic-inorganic composite film, wherein the mixture solution of zinc oxide nanoparticles and an organic electrically-conductive material is coated on a substrate 10 via a spin-coating method, and a phase-segregation technology is used to form a layered structure that zinc oxide nanoparticles 30 are separated from and distributed over an organic electrically-conductive material 20.

The zinc oxide nanoparticles 30 have a diameter of between 2 and 200 nm and form a plurality of circular holes or protrusions with a diameter of between 0.3 and 3 μm. The organic electrically-conductive material 20 is an organic semiconductor that benefits the passage of current, such as TDP (N,N′-diphenyl-N,N′-bis(3-methylphenyl)-1,1′-biphenyl-4,4′-diamine). In the layered structure, the ratio of the thickness of the zinc oxide nanoparticles to the thickness of the organic electrically-conductive material is 1:1; for example, when the organic-inorganic composite film has a thickness of 2.0 μm, the zinc oxide nanoparticle layer and the organic electrically-conductive material layer respectively have a thickness of 1.0 μm. The organic-inorganic composite film generally has a thickness of between 0.5 and 2.0 μm. The organic-inorganic composite film may also comprise an organic material with a good film-forming property; the organic electrically-conductive material and the organic film-forming material will intermix and codeposit on the substrate 10. The organic film-forming material may be an organic insulating material, which allows current to pass, or an organic semiconductor, which may conduct current. The organic insulating material may be PMMA (poly(methyl methacrylate).

Below, a preferred embodiment is used to exemplify the process of fabricating an electroluminescent element with the organic-inorganic composite film of the present invention. In this embodiment, a transparent ITO (Indium Tin Oxide)-coated glass with a sheet resistance of 7Ω is used as the substrate, and the blue light-emitting element is made of zinc oxide nanoparticles having a diameter of 90 nm.

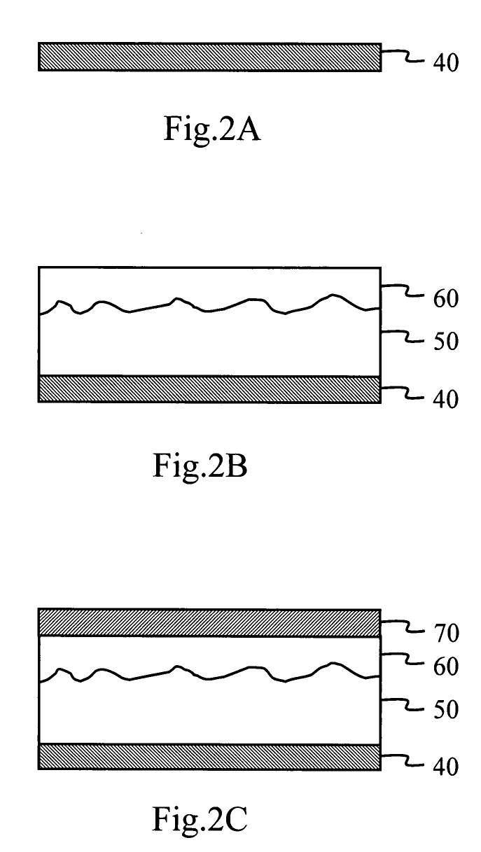

Refer to from FIG. 2A to FIG. 2C. The steps of fabricating an electroluminescent element with the zinc oxide nanoparticle-containing organic-inorganic composite film are described below.

As shown in FIG. 2A, firstly, an ITO substrate 40 is provided, and isopropyl alcohol, acetone, methyl alcohol, and de-ionized water are sequentially used to clean the surface of the ITO substrate 40; then, the ITO substrate 40 is airdried with a nitrogen injector. The substrate 40 may also be a flexible electrically-conductive substrate.

As shown in FIG. 2B, zinc oxide nanoparticles having a diameter of 90 nm are added into toluene by a weight percentage of 2.1%, and the “solution” is placed in an ultrasonic vibrator for 5 hours. At the same time, PMMA and TDP are mixed by a weight ratio of 1:1, and the mixture is added into chloroform by a weight percentage of 1.5%, and the solution is placed in an ultrasonic vibrator for 15 minutes. Then, the abovementioned two solutions are mixed by a volume ratio of 1:1, and the mixture solution is placed in an ultrasonic vibrator for 1 minute; thus, the mixture solution for fabricating the zinc oxide nanoparticle-containing organic-inorganic composite film is attained, wherein the concentration of PMMA:TDP plus zinc oxide nanoparticles is about 0.7-2.5% by weight.

PMMA is used to improve the film-forming property, and TPD is a hole-transporting material and used to increase the number of holes. As the glass transition temperature of TPD is 60°, the chloroform solution of TPD, which is colorless originally, should not be placed in the ultrasonic vibrator for too long a time (15 minutes is appropriate); otherwise, the solution will become pale yellow.

The mixture solution is applied onto the ITO substrate 40 with a spin-coating method. Then, the substrate 40 is annealed at 60° for 2 hours to remove toluene and chloroform and increase the adhesiveness between the film and the ITO substrate 40. As zinc oxide nanoparticles 60 have different solubilities in different solvents, the zinc oxide nanoparticles 60 will be separated from PMMA:TPD 50 during spin-coating; thus, a two-layer zinc oxide nanoparticle-containing organic-inorganic composite film is formed. The two solvents may be selected from the group consisting of chloroform, dichloromethane, toluene and tetrahydrofuran according to practical requirements.

As shown in FIG. 2C, an aluminum layer with a thickness of 200 nm is coated on the zinc oxide nanoparticle-containing organic-inorganic composite film via a thermal evaporation deposition method to function as a conduction layer 70 and define the emitting area, which is 0.7 cm*0.3 cm in this embodiment. Thus, the zinc oxide nanoparticle-containing electroluminescent element of the present invention is completed.

Below, several experiments are used to verify the efficacies of the present invention.

After the zinc oxide nanoparticle-containing organic-inorganic composite film is completed with a spin-coating method, the surface of the film is observed with a microscope at 100× magnification. It is observed that zinc oxide nanoparticles are uniformly distributed on the surface. Such a phenomenon is due to the film-forming property improved by PMMA and zinc oxide nanoparticles having different solubilities in different solvents (toluene and chloroform). Both factors cause the separation of zinc oxide nanoparticles and PMMA:TPD during spin-coating. Next, a confocal microscope is used to observe the surface of the film and the plane 1000 nm below the surface. It is found that zinc oxide nanoparticles aggregate on the surface of the film, and the plane 1000 nm below the surface has much fewer zinc oxide nanoparticles. Besides, the confocal microscope is also used to observe the depth profile of the film. It is found that the depth profile is similar to FIG. 1, and that most of zinc oxide nanoparticles are distributed on the upper layer and separated from the layer of PMMA:TPD.

However, the abovementioned phase segregation cannot be achieved so easily. To achieve phase segregation, the related parameters should be appropriately selected, such as the ratio of zinc oxide nanoparticles to PMMA:TPD, the solvents, the concentration of the related components in the solvents, the spin-coating speed, etc. If the parameters are inappropriate, zinc oxide nanoparticles will not segregate from PMMA:TPD but will agglomerate.

The layered structure can promote the probability of the recombination of the electron-hole pairs in zinc oxide nanoparticles, wherein TPD purely functions to transport holes. The ITO layer injects holes to HOMO (Highest Occupied Molecular Orbital) of TPD; the holes are then transferred to the valence band of zinc oxide. The cathode (the aluminum layer) injects electrons to the conduction band of zinc oxide. Then, the combination of electron-hole pairs forms excitons in zinc oxide nanoparticles. Therefore, the electroluminescent spectrum, which is emitted by the electroluminescent element having the structure of ITO/TPD:PMMA/ZnO nanoparticles/Al, completely corresponds to the band-gap energy of zinc oxide.

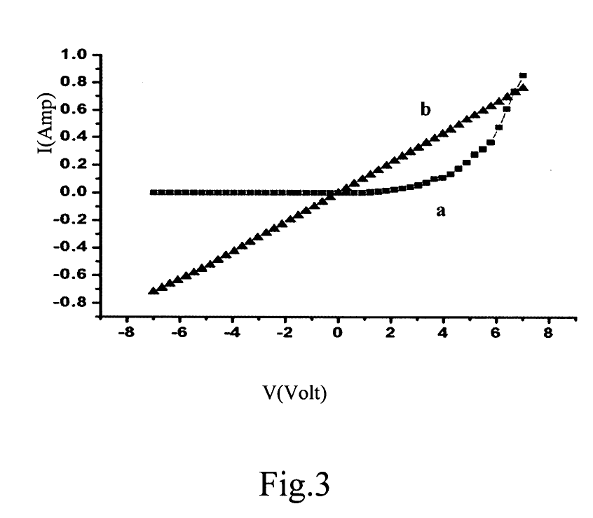

Refer to FIG. 3 a diagram showing the I-V curves of electroluminescent elements. When the electroluminescent element is made of a phase-segregated film (having the structure of ITO/TPD:PMMA/ZnO nanoparticles/Al), the I-V curve thereof is Curve (a), and the driving voltage thereof is about 5V. When the electroluminescent element is made of a film without phase segregation (having the structure of ITO/TPD/ZnO nanoparticles/Al), the I-V curve thereof is Curve (b), which exhibits no rectification behavior. Therefore, phase segregation is a critical factor for the I-V behaviors of electroluminescent elements.

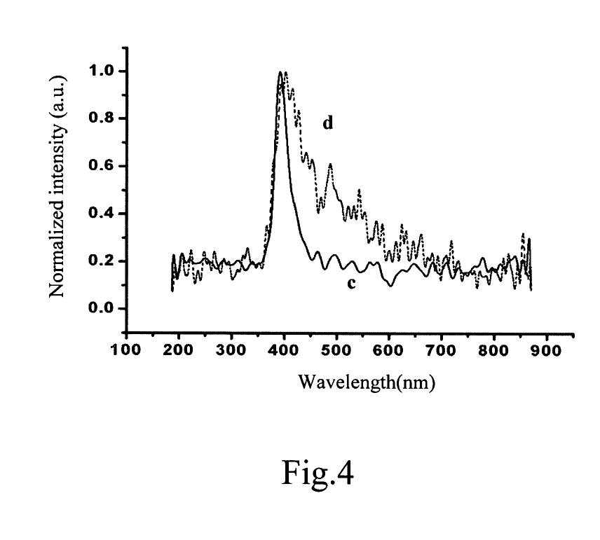

Refer to FIG. 4 a diagram showing the electroluminescent spectra of electroluminescent elements. The electroluminescent spectrum (Curve (c)) of the electroluminescent element made of 90 nm zinc oxide nanoparticles has a very steep peak at a wavelength of 392 nm; the FWHN (Full Width at Half Maximum) of the spectrum is 35 nm. As the 90 nm zinc oxide nanoparticles are free from the influence of surface oxygen vacancies, the wavelength completely corresponds to the band-gap energy (3.3 eV) of zinc oxide. The same parameters for phase segregation can also apply to the zinc oxide nanoparticles with a different size. When the zinc oxide nanoparticles have a diameter of 20 nm, the electroluminescent element has a wider spectrum (Curve (d)), which almost covers the entire spectrum of visible light. Such a phenomenon is due to the higher ratio of surface area to volume of the 20 nm zinc oxide nanoparticles, which greatly increases the surface oxygen vacancies of the zinc oxide nanoparticles. Thus, different electroluminescent spectra can be obtained via different-size zinc oxide nanoparticles.

In conclusion, the present invention utilizes a spin-coating technology and a phase-segregation technology to fabricate a zinc oxide nanoparticle-containing organic-inorganic composite film and realizes an electroluminescent element with the same composite film, and a low-cost light-emitting element for ultraviolet light or blue light can thus be achieved. In addition to ITO-coated glass substrate, the present invention can also apply to a flexible electrically-conductive substrate. In comparison with the conventional complicated, expensive and small-area epitaxial process, the present invention can fabricate a large-area element and can thus greatly expand the application field.

Those described above are the preferred embodiments to exemplify the present invention. However, it is not intended to limit the scope of the present invention. Any equivalent modification or variation according to the spirit of the present invention is to be also included within the scope of the present invention, which is based on the claims stated below.

What is claimed is:

1. A zinc oxide nanoparticle-containing organic-inorganic composite film, formed for spin-coating on a substrate comprising:
a mixture solution including a plurality of zinc oxide nanoparticles and an organic electrically-conductive material,
said zinc oxide nanoparticles being distributed over said organic electrically-conductive material in phase segregated manner.

2. The zinc oxide nanoparticle-containing organic-inorganic composite film according to claim 1, wherein said organic electrically-conductive material is an organic semiconductor for aiding the passage of current.

3. The zinc oxide nanoparticle-containing organic-inorganic composite film according to claim 2, wherein said organic semiconductor is N,N′-diphenyl-N,N′-bis(3-methylphenyl)-1,1′-biphenyl-4,4′-diamine (TPD).

4. The zinc oxide nanoparticle-containing organic-inorganic composite film according to claim 1, further comprising an organic film-forming material, wherein said organic electrically-conductive material and said organic film-forming material are intermixed and co-deposited on said substrate.

5. The zinc oxide nanoparticle-containing organic-inorganic composite film according to claim 4, wherein said organic film-forming material includes at least one of an organic insulating material or an organic semiconductor.

6. The zinc oxide nanoparticle-containing organic-inorganic composite film according to claim 5, wherein said organic insulating material is poly-methyl methacrylate (PMMA).

7. The zinc oxide nanoparticle-containing organic-inorganic composite film according to claim 1, wherein said zinc oxide nanoparticles have a diameter of between 2 and 200 nm.

8. The zinc oxide nanoparticle-containing organic-inorganic composite film according to claim 1, wherein said zinc oxide nanoparticles form a plurality of circular holes or protrusions with a diameter of between 0.3 and 3 μm.

9. The zinc oxide nanoparticle-containing organic-inorganic composite film according to claim 1, wherein after phase segregation, the ratio of a thickness of said zinc oxide nanoparticles to a thickness of said organic electrically-conductive material is 1:1; said organic-inorganic composite film having a thickness of between 0.5 and 2.0 μm.

10. A zinc oxide nanoparticle-containing electroluminescent element, comprising:
a substrate;
a zinc oxide nanoparticle-containing organic-inorganic composite film formed via spin-coating a mixture solution of zinc oxide nanoparticles and an organic electrically-conductive material on said substrate with said zinc oxide nanoparticles distributed over said organic electrically-conductive material in phase segregatied manner; and
a conduction layer formed over said zinc oxide nanoparticles of said organic-inorganic composite film.

11. The zinc oxide nanoparticle-containing electroluminescent element according to claim 10, wherein said substrate is selected from the consisting of: a transparent Indium Tin Oxide (ITO) coated glass material and a flexible electrically-conductive material.

12. The zinc oxide nanoparticle-containing electroluminescent element according to claim 10, wherein said organic electrically-conductive material is an organic semiconductor for aiding the passage of current.

13. The zinc oxide nanoparticle-containing electroluminescent element according to claim 12, wherein said organic semiconductor is N,N′-diphenyl-N,N′-bis(3-methylphenyl)-1,1′-biphenyl-4,4′-diamine (TPD).

14. The zinc oxide nanoparticle-containing electroluminescent element according to claim 10, wherein said organic-inorganic composite film further comprises an organic film-forming material; said organic electrically-conductive material and said organic film-forming material being intermixed and codeposited on said substrate.

15. The zinc oxide nanoparticle-containing electroluminescent element according to claim 14, wherein said organic film-forming material includes at least one of an organic insulating material or an organic semiconductor.

16. The zinc oxide nanoparticle-containing electroluminescent element according to claim 15, wherein said organic insulating material is poly-methyl methacrylate (PMMA).

17. The zinc oxide nanoparticle-containing electroluminescent element according to claim 10, wherein said zinc oxide nanoparticles have a diameter of between 2 and 200 nm.

18. The zinc oxide nanoparticle-containing electroluminescent element according to claim 10, wherein said zinc oxide nanoparticles form a plurality of circular holes or protrusions with a diameter of between 0.3 and 3 μm.

19. The zinc oxide nanoparticle-containing electroluminescent element according to claim 10, wherein after phase segregation, the ratio of a thickness of said zinc oxide nanoparticles to a thickness of said organic electrically-conductive material is 1:1; said organic-inorganic composite film having a thickness of between 0.5 and 2.0 μm.

20. The zinc oxide nanoparticle-containing electroluminescent element according to claim 10, wherein said conduction layer is made of aluminum.

21. A method for fabricating a zinc oxide nanoparticle-containing organic-inorganic composite film, comprising the steps of:
providing a substrate; and
spin-coating a mixture solution of zinc oxide nanoparticles and an organic electrically-conductive material on said substrate, and distributing said zinc oxide nanoparticles over said organic electrically-conductive material via phase segregation to attain said organic-inorganic composite film.

22. The method for fabricating a zinc oxide nanoparticle-containing organic-inorganic composite film according to claim 21, wherein said zinc oxide nanoparticles have a diameter of between 2 and 200 nm.

23. The method for fabricating a zinc oxide nanoparticle-containing organic-inorganic composite film according to claim 21, wherein in the step of spin-coating said mixture solution of said zinc oxide nanoparticles and said organic electrically-conductive material on said substrate, said mixture solution is prepared via respectively dissolving said zinc oxide nanoparticles and said organic electrically-conductive material in a first solvent and a second solvent and mixing the two solutions, said zinc oxide nanoparticles having different solubilities in said first solvent and said second solvent.

24. The method for fabricating a zinc oxide nanoparticle-containing organic-inorganic composite film according to claim 23, wherein said first solvent is selected from the group consisting of: chloroform, dichloromethane, toluene, and tetrahydrofuran.

25. The method for fabricating a zinc oxide nanoparticle-containing organic-inorganic composite film according to claim 23, wherein said second solvent is selected from the group consisting of: chloroform, dichloromethane, toluene, and tetrahydrofuran.

26. The method for fabricating a zinc oxide nanoparticle-containing organic-inorganic composite film according to claim 23, wherein said organic electrically-conductive material together with an organic film-forming material is dissolved in said second solvent, and said organic electrically-conductive material and said organic film-forming material codeposit on said substrate.

27. The method for fabricating a zinc oxide nanoparticle-containing organic-inorganic composite film according to claim 26, wherein said organic film-forming material includes at least one of an organic insulating material or an organic semiconductor.

28. The method for fabricating a zinc oxide nanoparticle-containing organic-inorganic composite film according to claim 27, wherein said organic insulating material is poly-methyl methacrylate (PMMA).

29. The method for fabricating a zinc oxide nanoparticle-containing organic-inorganic composite film according to claim 23, wherein after the step of spin-coating said mixture solution of said zinc oxide nanoparticles and said organic electrically-conductive material on said substrate, an annealing process is performed to remove said first solvent and said second solvent and increase the adhesiveness between said organic-inorganic composite film and said substrate.

30. The method for fabricating a zinc oxide nanoparticle-containing organic-inorganic composite film according to claim 21, wherein said organic electrically-conductive material is an organic semiconductor.

31. The method for fabricating a zinc oxide nanoparticle-containing organic-inorganic composite film according to claim 30, wherein said organic semiconductor is N,N′-diphenyl-N,N′-bis(3-methylphenyl)-1,1′-biphenyl-4,4′-diamine (TPD).

32. The method for fabricating a zinc oxide nanoparticle-containing organic-inorganic composite film according to claim 21, wherein a concentration of said mixture solution is about 0.7-2.5% by weight.

33. The method for fabricating a zinc oxide nanoparticle-containing organic-inorganic composite film according to claim 21, wherein said zinc oxide nanoparticles form a plurality of circular holes or protrusions with a diameter of between 0.3 and 3 μm.

34. The method for fabricating a zinc oxide nanoparticle-containing organic-inorganic composite film according to claim 21, wherein after phase segregation, the ratio of a thickness of said zinc oxide nanoparticles to a thickness of said organic electrically-conductive material is 1:1, and said organic-inorganic composite film has a thickness of between 0.5 and 2.0 μm.
